(19) United States
(12) Patent Application Publication
(10) Pub. No.: US 2005/0008309 A1
(43) Pub. Date: Jan. 13, 2005

(54) Quadrangular-pyramid-shaped lensed fiber and the method of making the same

(75) Inventors: Yu-Kuan Lu, Caotun Township (TW); Szu-Ming Yeh, Kaohsiung (TW); Wood-Hi Cheng, Kaohsiung (TW)

Correspondence Address: SENNIGER POWERS LEAVITT AND ROEDEL, ONE METROPOLITAN SQUARE, 16TH FLOOR, ST LOUIS, MO, 63102, US

(73) Assignee: National Sun Yat-Sen University

(21) Appl. No.: 10/881,482

(22) Filed: Jun. 30, 2004

(30) Foreign Application Priority Data
Jul. 7, 2003 (TW) 092118496

(51) Int. Cl. G02B 6/02

(52) U.S. Cl. 385/123

(57) ABSTRACT

The present invention relates to a quadrangular-pyramid-shaped lensed fiber. One end of the fiber is ground to become quadrangular-pyramid-shaped. Small volume of the tip of the quadrangular-pyramid-shaped fiber is heated to form a semi-ellipsoidal microlens, thereby forming the quadrangular-pyramid-shaped lensed fiber. The advantage of the present invention is that the shape of the semi-ellipsoidal microlens can be controlled by adjusting the angles of the quadrangular-pyramid-shaped fiber according to the aspect ratio of the diode laser so as to enhance the coupling efficiency between an optical fiber and a diode laser.

### FIELD OF THE INVENTION

The present invention relates to a lensed fiber and the method of making the same, particularly to a quadrangular-pyramid-shaped lensed fiber and the method of making the same.

### DESCRIPTION OF THE RELATED ART

For optimal performance in fiber-optic communication system, efficient coupling between diode laser and fiber is essential. In order to enhance the coupling efficiency between diode laser and fiber, various types of lensed fibers are provided as follows.

Referring to FIG. 1, U.S. Pat. No. 4,671,609 disclosed a method of making a lensed fiber comprising the following steps. A fiber 10 was pulled to form a tapered end that has a flat end face 12 or a rounded tip. A lens 14 is formed by immersing the tapered end of the fiber 10 in molten glass and then withdrawing the tapered end from the molten glass. The dimensions and the shape of the lens 14 can be influenced by the immersion depth, the angles of the tapered end, the shape of the tapered end and the temperature of the molten glass, which cause the manufacturing process to be complicated, time consuming and difficult to control, which are the disadvantages of this method. In addition, the rounded lensed fiber fabricated by this method is only suitable for the laser of low aspect ratio.

Referring to FIG. 2, U.S. Pat. No. 5,037,174 disclosed a method for making a tapered fiber comprising the following steps. A fiber was drawn to be separated into two parts by jerking separation and little heat of arc energy, and a tapered extension 22 and a nipple-like extension 24 were formed on the end of one part. Then, the application of a burst of arc softened the nipple-like extension 24 to form a hyperbolic shaped fiber lens 26. The disadvantage of this method is that the dimensions and the shapes of the tapered extension 22 and nipple-like extension 24 are difficult to control and unstable during the manufacturing process. In addition, the rounded lensed fiber fabricated by this method is only suitable for the laser of low aspect ratio.

Referring to FIG. 3, U.S. Pat. No. 5,256,851 disclosed a method for making a tapered fiber comprising the following steps. A fiber 30 was rotated along the axis thereof, and then a CO₂ laser controlled by computer program was applied to the fiber 30 to form a lens consisting of a hyperbolical portion 32 on an axis and a spherical portion 34 on another axis. Such a fiber lens has high coupling efficiency, but it is very difficult to fabricate a fiber lens having an asymmetric curve.

Referring to FIG. 4, U.S. Pat. No. 5,256,851 disclosed an optical fiber having a lens of a wedge-shaped external form having two-stage tapered portions and with different angles of θ₁ and θ₂ between the two slants and the axis 42, respectively, wherein the intersection of the two slants must be controlled to be within the scope of the core of the fiber. Such wedge-shaped fiber is most widely used as a lensed fiber for coupling between 980-nm laser diode and single-mode fiber. However, the fabricating process of the wedge-shaped fiber lens only controls one axial curvature. Therefore, it is difficult to form any different aspect ratios of elliptical curvatures to match the far field of high power diode lasers. In addition, as the radius of the core of the fiber is usually 4 to 6 μm, it is very difficult to control the intersection of the two slants to be within the scope of the core of the fiber. Furthermore, the lensed fiber fabricated by this method is only suitable for the laser of high aspect ratio.

Consequently, there is a need for improved quadrangular-pyramid-shaped lensed fiber and the method of making the same to solve the above-mentioned problem.

### SUMMARY OF THE INVENTION

The primary objective of the present invention is that the shape of the optical fiber can be controlled by adjusting the angles of the quadrangular-pyramid-shaped fiber according to the aspect ratio of the diode laser so as to enhance the coupling efficiency between an optical fiber and a diode laser.

Another objective of the present invention is to provide a quadrangular-pyramid-shaped lensed fiber, which is easy to fabricate, and the fabricating method is polishing the tip of an optical fiber to form four slants and an apex, and then fusing the apex.

To achieve the above method, the present invention provides a quadrangular-pyramid-shaped lensed fiber comprising an optical fiber and a tapered region. The optical fiber has a central axis and an end. The tapered region is at the end of the optical fiber. The tapered region has four slants, four edges and a fiber lens. Two of the four slants intersect each other to form the four edges, and the extension of the four edges cross at an intersection point on the central axis. Two separate edges of the four edges and the central axis are on the same plane. The fiber lens is at the tip of the tapered region, and the geometric center of the fiber lens is on the central axis.

Additionally, the present invention provides a method for making a quadrangular-pyramid-shaped lensed fiber, comprising:
(a) providing an optical fiber having a central axis and an end;
(b) cutting the end of the optical fiber to form a flat end face;
(c) forming a tapered region at the end of the optical fiber, wherein the tapered region has four slants, four edges and an apex, two of the four slants intersect each other to form the apex with the four edges, the apex is on the central axis, and two separate edges of the four edges and the central axis are on the same plane; and
(d) fusing the apex to form a fiber lens.

### BRIEF DESCRIPTION OF THE DRAWINGS

FIG. 1 shows the conventional fiber lens of U.S. Pat. No. 4,671,609;

FIG. 2 shows the typical method disclosed in U.S. Pat. No. 5,037,174, in which the tapered fiber is fabricated by arc welding;

FIG. 3 shows the conventional asymmetric fiber lens of U.S. Pat. No. 5,256,851;

FIG. 4 shows the conventional wedge fiber lens of U.S. Pat. No. 5,455,879;

FIG. 5a is a perspective view of a quadrangular-pyramid-shaped fiber according to the first embodiment of the present invention;

FIG. 5b is a side view of the quadrangular-pyramid-shaped fiber of FIG. 5a;

FIG. 5c is a top view of the quadrangular-pyramid-shaped fiber of FIG. 5a;

FIG. 5d is a front view of the quadrangular-pyramid-shaped fiber of FIG. 5a;

FIG. 6a is a perspective view of a quadrangular-pyramid-shaped lensed fiber according to the second embodiment of the present invention;

FIG. 6b is a side view of the quadrangular-pyramid-shaped lensed fiber of FIG. 6a;

FIG. 6c is a top view of the quadrangular-pyramid-shaped lensed fiber of FIG. 6a;

FIG. 6d is a front view of the quadrangular-pyramid-shaped lensed fiber of FIG. 6a;

FIG. 7 shows the machining apparatus of the present invention;

FIG. 8 shows the relative position between a laser and a optical fiber; and

FIG. 9 shows the relationship between the coupling efficiency and the working distance.

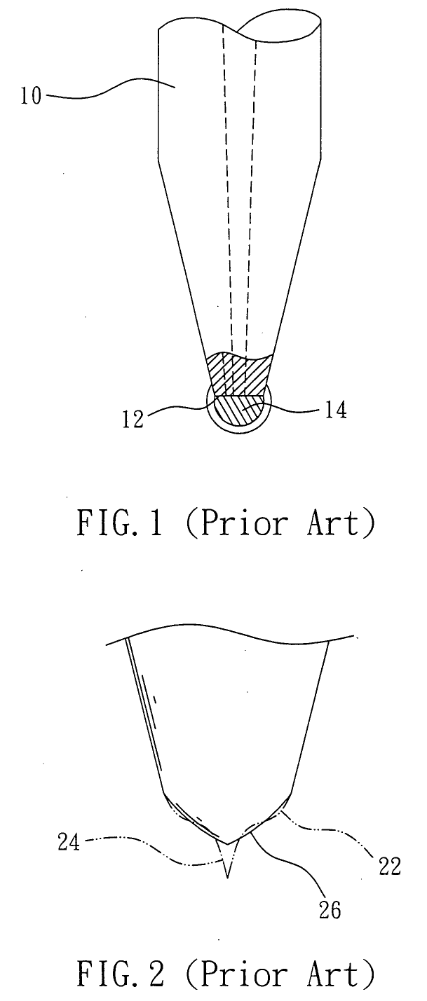

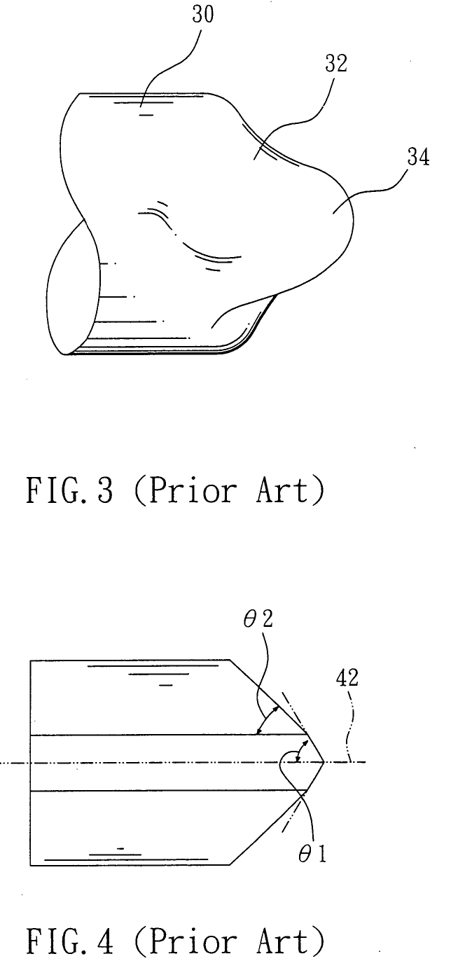

### DETAILED DESCRIPTION OF THE INVENTION

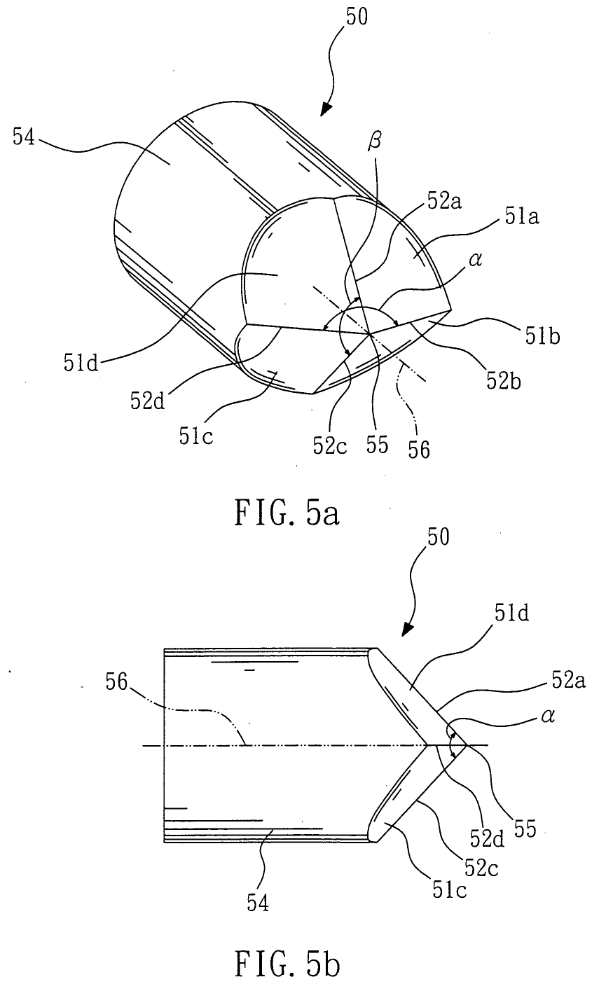

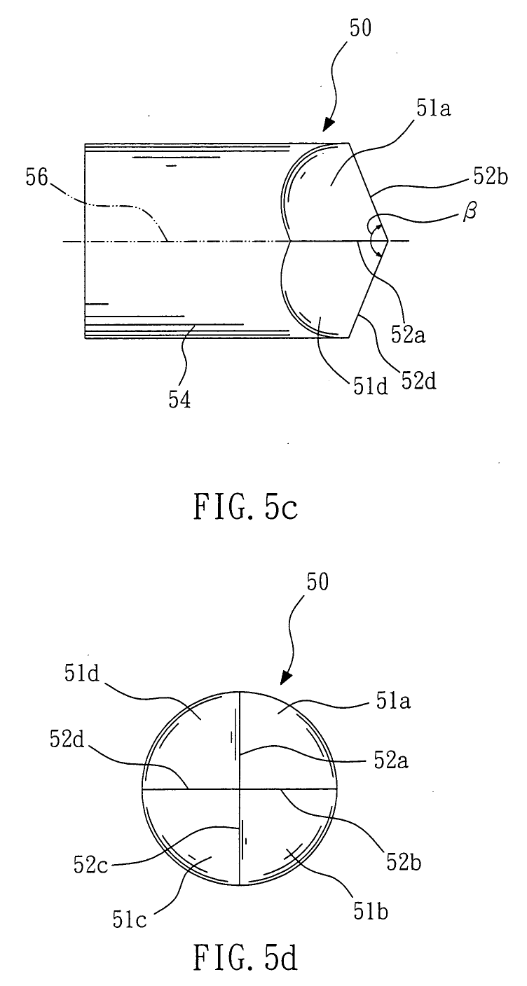

Referring to FIG. 5a, a quadrangular-pyramid-shaped fiber according to the first embodiment of the present invention is shown. In the embodiment, the quadrangular-pyramid-shaped fiber 50, fabricated by polishing an optical fiber 54, comprises an optical fiber 54 and a tapered region.

The optical fiber 54 has a central axis 56 extending in the longitudinal direction thereof. The tapered region is at one end of the optical fiber 54 and has four slants 51a, 51b, 51c, 51d, four edges 52a, 52b, 52c, 52d and an apex 55. The four slants are a first slant 51a, a second slants 51b, a third slants 51c and a fourth slant 51d. The four slants 51a, 51b, 51c, 51d intersect each other to form four edges which are a first edge 52a, a second edge 52b, a third edge 52c and a fourth edge 52d, wherein the first slant 51a intersect the fourth slant 51d to form the first edge 52a, the first slant 51a intersect the second slant 51b to form the second edge 52b, the second slant 51b intersect the third slant 51c to form the third edge 52c, and the third slant 51c intersect the fourth slant 51d to form the fourth edge 52d.

The four edges 52a, 52b, 52c, 52d intersect at the apex 55, which is on the central axis 56. Two separate edges of the four edges 52a, 52b, 52c, 52d and the central axis 56 are on the same plane. For example, referring to FIG. 5b, the first edge 52a, the third edge 52c and the central axis 56 are on a first plane, and the central axis 56 divides the inclination angle α (α is 10 degrees to 170 degrees) between the first edge 52a and the third edge 52c equally. Hence, the first inclination angle between the first edge 52a and the central axis 56 is α/2, and the third inclination angle between the third edge 52c and the central axis 56 is also α/2.

Referring to FIG. 5c, the second edge 52b, the fourth edge 52d and the central axis 56 are on a second plane, and the central axis 56 divides the inclination angle β (β is 10 degrees to 170 degrees) between the second edge 52b and the fourth edge 52d equally. Hence, the second inclination angle between the second edge 52b and the central axis 56 is β/2, and the fourth inclination angle between the fourth edge 52d and the central axis 56 is also β/2.

Referring to FIG. 5d, a front view of a quadrangular-pyramid-shaped fiber of FIG. 5a is shown. In this embodiment, the first plane defined by the first edge 52a and the third edge 52c is perpendicular to the second plane defined by the second edge 52b and the fourth edge 52d.

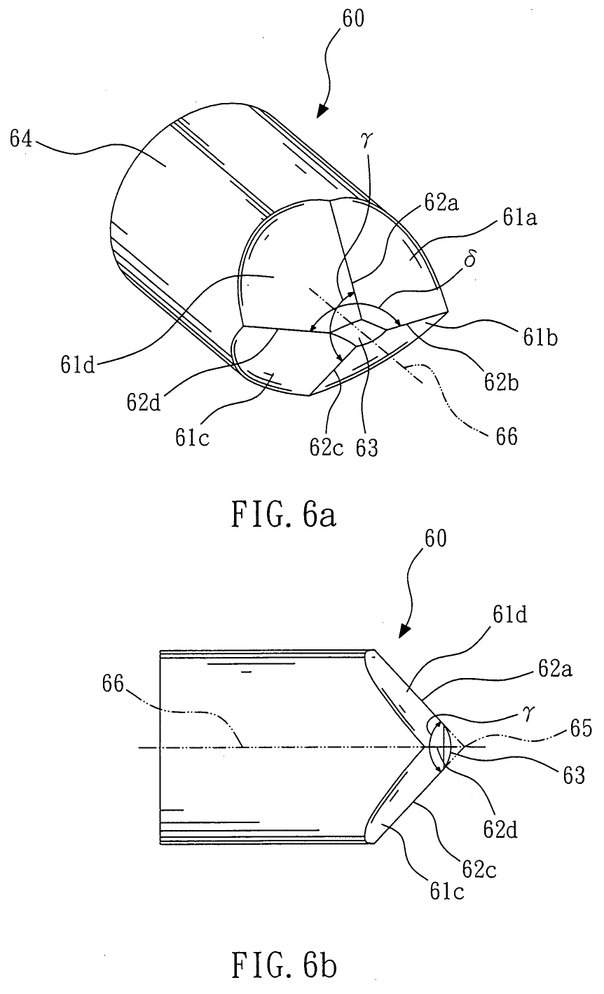

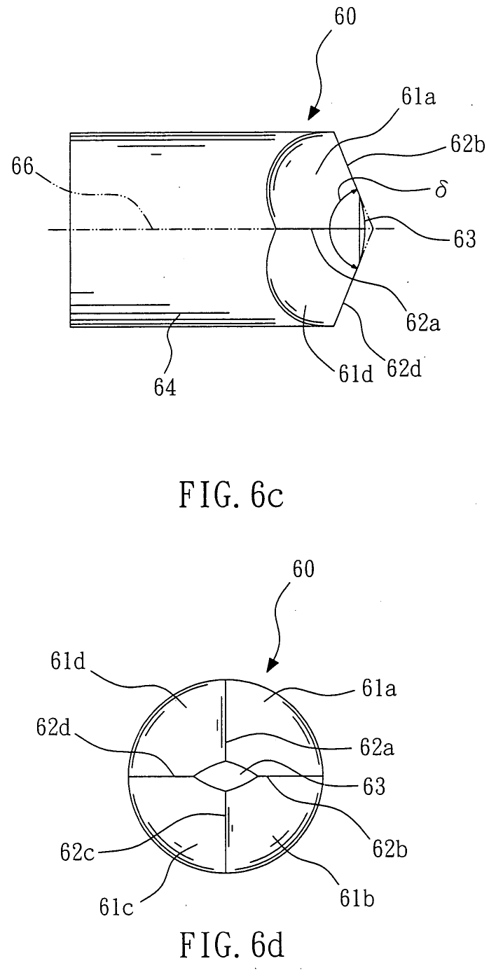

Referring to FIG. 6a, a perspective view of a quadrangular-pyramid-shaped lensed fiber according to the second embodiment of the present invention is shown. In this embodiment, a quadrangular-pyramid-shaped lensed fiber 60 is formed by fusing the apex 55 of the quadrangular-pyramid-shaped fiber 50 of FIG. 5a. The elements in FIGS. 6a to 6d are substantially same as those in FIGS. 5a to 5d, and are designated by the reference numbers of FIGS. 5a to 5d plus 10. In the embodiment, the quadrangular-pyramid-shaped lensed fiber 60 comprises an optical fiber 64, a tapered region and fiber lens 63.

The optical fiber 64 has a central axis 66 extending in the longitudinal direction thereof. The tapered region is at one end of the optical fiber 64 and has four slants 61a, 61b, 61c, 61d and four edges 62a, 62b, 62c, 62d. The four slants are a first slant 61a, a second slants 61b, a third slants 61c and a fourth slant 61d. The four slants 61a, 61b, 61c, 61d intersect each other to form the four edges which are a first edge 62a, a second edge 62b, a third edge 62c and a fourth edge 62d, wherein the first slant 61a intersect the fourth slant 61d to form the first edge 62a, the first slant 61a intersect the second slant 61b to form the second edge 62b, the second slant 61b intersect the third slant 61c to form the third edge 62c, and the third slant 61c intersect the fourth slant 61d to form the fourth edge 62d.

The extension of the four edges 62a, 62b, 62c, 62d cross at a intersection point 65, which is on the central axis 66. Two separate edges of the four edges 62a, 62b, 62c, 62d and the central axis 56 are on the same plane. For example, referring to FIG. 6b, the first edge 62a, the third edge 62c and the central axis 66 are on a first plane, and the central axis 66 divides the inclination angle γ ( γ is 10 degrees to 170 degrees) between the first edge 62a and the third edge 62c equally. Hence, the first inclination angle between the first edge 62a and the central axis 66 is γ/2, and the third inclination angle between the third edge 62c and the central axis 66 is also γ/2.

Referring to FIG. 6c, the second edge 62b, the fourth edge 62d and the central axis 66 are on a second plane, and the central axis 66 divides the inclination angle δ (δ is 10 degrees to 170 degrees) between the second edge 62b and the fourth 62d equally. Hence, the second inclination angle between the second edge 62b and the central axis 66 is δ/2, and the fourth inclination angle between the fourth edge 62d and the central axis 66 is also δ/2.

Referring to FIG. 6d, a front view of a quadrangular-pyramid-shaped fiber of FIG. 6a is shown. In this embodiment, the first plane defined by the first edge 62a and the third edge 62c is perpendicular to the second plane defined by the second edge 62b and the fourth edge 62d.

The fiber lens 63 is at the tip of the tapered region, and the geometric center of the fiber lens 63 is on the central axis 66. The appearance of the fiber lens 63 can be semi-ellipsoidal or hemispherical.

The present invention also relates to a method for making a quadrangular-pyramid-shaped lensed fiber, comprising the following steps:
(a) providing an optical fiber having a central axis and an end;
(b) cutting the end of the optical fiber to form a flat end face;
(c) machining (for example, lapping, polishing or grinding) the end of the optical fiber to form a tapered region like the above-mentioned quadrangular-pyramid-shaped fiber 50, wherein the tapered region has four slants, four edges and a apex, two of the four slants intersect each other to form the apex with the four edges, the apex is on the central axis, and two separate edges of the four edges and the central axis are on the same plane; and
(d) fusing the apex by electric arcs so that the apex is melted to become liquid state and then forms a fiber lens by surface tension, wherein the appearance of the fiber lens is like the above-mentioned quadrangular-pyramid-shaped lensed fiber 60.

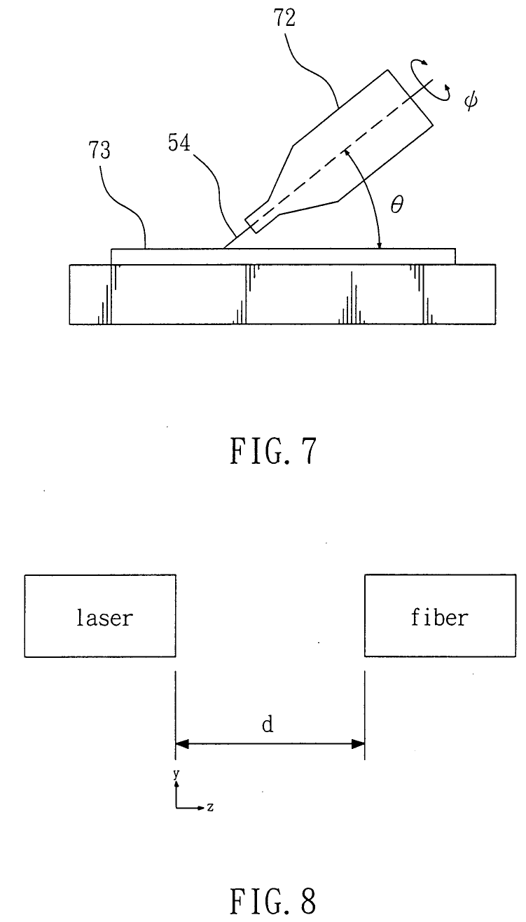

Referring to FIG. 7, the above-mentioned machining step of step (c) further comprises the following steps (taking the fabrication of the quadrangular-pyramid-shaped fiber 50 for example):
(c1) fixing the optical fiber 54 in a fixture 72 above a machining plate 73 (for example, lapping plate or polishing plate);
(c2) adjusting the inclination angle between the fixture 72 and the machining plate 73 to form a first angle θ between the optical fiber 54 and the surface of the machining plate 73;
(c3) machining (for example, lapping, polishing or grinding) the end of the optical fiber 54 to form the first slant 51a;
(c4) rotating the optical fiber 54 along the central axis 56 with a second angle φ;
(c5) machining the optical fiber 54 to form the second slant 51b and the second edge 52b;
(c6) rotating the optical fiber 54 along the central axis 56 with an angle of the supplementary angle of the second angle φ;
(c7) machining the optical fiber 54 to form the third slant 51c and the third edge 52c;
(c8) rotating the optical fiber 54 along the central axis 56 with the second angle φ; and
(c9) machining the optical fiber 54 to form the fourth slant 51d, fourth edge 52d and first edge 52a.

The advantage of the present invention is that the best coupling efficiency can be achieved by adjusting the inner angles α and β of the quadrangular-pyramid-shaped optical fiber 50 to control the shape of the fused fiber lens 63 of the quadrangular-pyramid-shaped lensed fiber 60 according to the aspect ratio of the laser. In a theoretical simulation, the coupling efficiency can reach 90% when the quadrangular-pyramid-shaped lensed fiber of the present invention matches the far field of laser.

An example is described below. In the example, a 980-nm high-power diode laser with a typical far-field divergence of 8° (lateral)×40° (vertical) is used, and the fiber used in this example is Prime 980-nm step-index single-mode fiber with the mold field radius of 4.916 μm, while the refractive index of the core is 1.416.

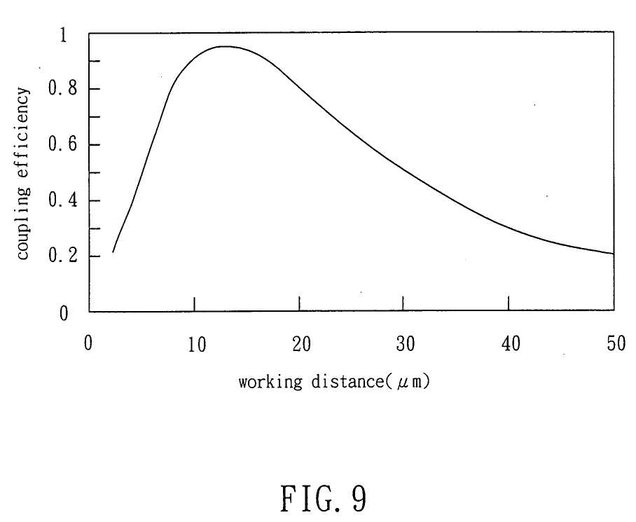

Then, the relative position between the laser and the fiber is defined. As shown in FIG. 8, the x direction is perpendicular to the paper, and the distance between the laser and the fiber along z direction is defined as the working distance d. Referring to the simulation result diagram of FIG. 9, the coupling efficiency is 95% when the working distance d is 13.5 μm.

According to the theoretical deduction, the widths of the laser are Wₓ=4.557 μm and W_{y}=4.916 μm, wherein Wₓ is the width in the x direction and W_{y} is the width in the y direction, and the radii of the laser are Rₓ=319.3 μm and R_{y}=13.7 μm, wherein Rₓ is the curvature in the x direction and R_{y} is the curvature in the y direction.

If the laser mode phase changed by the fiber lens can totally match the fiber mode phase, the two lens curvatures of the fiber lens in perpendicular are Rₗₓ=143.7 μm and R_{ly}=6.4 μm, wherein Rₗₓ, is the curvature in the x direction and R_{ly} is the curvature in the y direction.

The ratio of angles α and β can be derived by substituting R_{ly} and Rₗₓ into the following equation:

$$\frac{{R}_{lx}}{{R}_{ly}} = ( \frac{\frac{1}{sin \frac{α}{2}} - 1}{\frac{1}{sin \frac{β}{2}} - 1} )$$

Therefore, if the value of α is determined, the corresponding value of β can be determined. Then the values of angles θ and φ can be derived by substituting α and β into the two following equations:

$$\begin{matrix}θ = \frac{π}{2} - {cos}^{- 1} \frac{tan \frac{α}{2} tan \frac{β}{2}}{\sqrt{{tan}^{2} \frac{α}{2} {tan}^{2} \frac{β}{2} + {tan}^{2} \frac{α}{2} + {tan}^{2} \frac{β}{2}}} \\ ϕ = {cos}^{- 1} \frac{{tan}^{2} \frac{β}{2} - {tan}^{2} \frac{α}{2}}{{tan}^{2} \frac{β}{2} + {tan}^{2} \frac{α}{2}}\end{matrix}$$

The quadrangular-pyramid-shaped optical fiber 50 can be fabricated by applying the values of angles θ and φ to the above-mentioned method. Then, the quadrangular-pyramid-shaped lensed fiber 60 can be fabricated by fusing the apex 55 of the quadrangular-pyramid-shaped optical fiber 50 by electric arcs.

While several embodiments of this invention have been illustrated and described, various modifications and improvements can be made by those skilled in the art. The embodiments of this invention are therefore described in an illustrative but not restrictive sense. It is intended that this invention may not be limited to the particular forms as illustrated, and that all modifications that maintain the spirit and scope of this invention are within the scope as defined in the appended claims.

1. A quadrangular-pyramid-shaped fiber comprising:
an optical fiber having a central axis and an end; and
a tapered region at the end of the optical fiber, the tapered region having four slants, four edges and an apex, each two adjacent slants intersecting to form the edges, the four edges intersecting to form the apex, the apex being on the central axis, and two separate edges of the four edges and the central axis being on the same plane.

2. The quadrangular-pyramid-shaped fiber according to claim 1, wherein the inclination angle between the two separate edges of the four edges is 10 degrees to 170 degrees.

3. The quadrangular-pyramid-shaped fiber according to claim 1, wherein the four edges are a first edge, a second edge, a third edge and a fourth edge in sequence, wherein the first plane defined by the first edge and the third edge is perpendicular to the second plane defined by the second edge and the fourth edge.

4. The quadrangular-pyramid-shaped fiber according to claim 3, wherein the first inclination angle between the first edge and the central axis is equal to the third inclination angle between the third edge and the central axis.

5. The quadrangular-pyramid-shaped fiber according to claim 3, wherein the second inclination angle between the second edge and the central axis is equal to the fourth inclination angle between the fourth edge and the central axis.

6. A quadrangular-pyramid-shaped lensed fiber comprising:
an optical fiber having a central axis and an end; and
a tapered region at the end of the optical fiber, the tapered region having four slants, four edges and a fiber lens, each two adjacent slants intersecting to form the edges, the four edges intersecting to form the apex, the extension of the four edges crossing at a intersection point on the central axis, two separate edges of the four edges and the central axis being on the same plane, the fiber lens being at the tip of the tapered region, and the geometric center of the fiber lens being on the central axis.

7. The quadrangular-pyramid-shaped lensed fiber according to claim 6, wherein the inclination angle between the two separate edges of the four edges is 10 degrees to 170 degrees.

8. The quadrangular-pyramid-shaped lensed fiber according to claim 6, wherein the appearance of the fiber lens is semi-ellipsoidal.

9. The quadrangular-pyramid-shaped lensed fiber according to claim 7, wherein the four edges are a first edge, a second edge, a third edge and a fourth edge in sequence, and the first plane defined by the first edge and the third edge is perpendicular to the second plane defined by the second edge and the fourth edge.

10. The quadrangular-pyramid-shaped lensed fiber according to claim 9, wherein the first inclination angle between the first edge and the central axis is equal to the third inclination angle between the third edge and the central axis.

11. The quadrangular-pyramid-shaped lensed fiber according to claim 9, wherein the second inclination angle between the second edge and the central axis is equal to the fourth inclination angle between the fourth edge and the central axis

12. A method for making a quadrangular-pyramid-shaped lensed fiber, comprising:
(a) providing an optical fiber having a central axis and an end;
(b) cutting the end of the optical fiber to form a flat end face;
(c) forming a tapered region at the end of the optical fiber, wherein the tapered region has four slants, four edges and an apex, each two adjacent slants intersecting to form the edges, the four edges intersecting to form the apex, the apex is on the central axis, and two separate edges of the four edges and the central axis are on the same plane; and
(d) fusing the apex to form a fiber lens.

13. The method according to claim 12, wherein step (c) further comprises:
(c1) fixing the optical fiber in a fixture above a machining plate;
(c2) adjusting the inclination angle between the fixture and the machining plate to form a first angle between the optical fiber and the surface of the machining plate;
(c3) machining the end of the optical fiber to form a first slant;
(c4) rotating the optical fiber along the central axis with a second angle;
(c5) machining the optical fiber to form a second slant and a second edge;
(c6) rotating the optical fiber along the central axis with an angle of the supplementary angle of the second angle;
(c7) machining the optical fiber to form a third slant and a third edge;
(c8) rotating the optical fiber along the central axis with the second angle; and
(c9) machining the optical fiber to form a fourth slant, a fourth edge and a first edge.

14. The method according to claim 12, wherein the machining step in steps (c3), (c5), (c7) and (c9) is a lapping step.

15. The method according to claim 12, wherein the machining step in steps (c3), (c5), (c7) and (c9) is a polishing step.

16. The method according to claim 12, wherein the inclination angle between the two separate edges of the four edges is 10 degrees to 170 degrees.

17. The method according to claim 12, wherein the appearance of the fiber lens in step (d) is semi-ellipsoidal.

18. The method according to claim 13, wherein the first plane defined by the first edge and the third edge is perpendicular to the second plane defined by the second edge and the fourth edge.

19. The method according to claim 13, wherein the first inclination angle between the first edge and the central axis is equal to the third inclination angle between the third edge and the central axis.

20. The method according to claim 13, wherein the second inclination angle between the second edge and the central axis is equal to the fourth inclination angle between the fourth edge and the central axis.
